(19) United States
(12) Patent Application Publication
(10) Pub. No.: US 2017/0316572 A1
(43) Pub. Date: Nov. 2, 2017

(54) USER EQUIPMENT AND IMAGE PROCESSING METHOD AND APPARATUS

(71) Applicant: Huawei Technologies Co., Ltd., Shenzhen (CN)

(72) Inventors: Xin TAO, Hong Kong (CN); Jiaya JIA, Hong Kong (CN); Yadong LU, Shenzhen (CN)

(21) Appl. No.: 15/374,825

(22) Filed: Dec. 9, 2016

(30) Foreign Application Priority Data
Apr. 28, 2016 (CN) 201610280921.7

(51) Int. Cl. G06T 7/64; G06T 7/194; G06T 7/13

(52) U.S. Cl. CPC G06T 7/64; G06T 7/13; G06T 7/194; G06T 2207/20021

(57) ABSTRACT

The present disclosure discloses user equipment and an image processing method and apparatus, which relate to the field of information technologies and can improve accuracy in determining image depth information. The method includes: first obtaining an original image, then determining, according to the original image and at least two preset edge image blocks, a target blur value corresponding to a pixel in the original image, and finally, determining a depth value corresponding to the pixel in the original image according to the target blur value corresponding to the pixel in the original image. The present invention is applicable to determining of a blur value corresponding to a pixel in an image and determining of a depth value corresponding to the pixel in the image according to the blur value corresponding to the pixel in the image.

### CROSS-REFERENCE TO RELATED APPLICATION

This application claims priority to Chinese Patent Application No. 201610280921.7, filed on Apr. 28, 2016, which is hereby incorporated by reference in its entirety.

### TECHNICAL FIELD

The present disclosure relates to the field of information technologies, and in particular, to user equipment and an image processing method and apparatus.

### BACKGROUND

With development of information technologies, a computer image technology also develops. In the computer image field, three-dimensional information is projected to form a two-dimensional image, resulting in a loss of image depth information. However, in some situations, image depth information needs to be obtained.

There are many methods for obtaining image depth information. The methods may be mainly classified into two categories: an obtaining method based on a multi-frame image and an obtaining method based on a single-frame image. In some scenarios in actual application, multi-frame input data are not necessarily obtainable. One category of depth obtaining based on a single-frame image, which can be generally for only a situation of specific image content, requires obvious structure information in the image, using a geometric relationship between parallel lines, or the like. In another category of depth obtaining based on a single-frame image, image depth is obtained according to different defocus blurs in regions of different depth. However, in a prior-art method in which a defocus blur is used, a blur type is assumed, and a situation is generally dealt with in which there is a relatively large difference between a foreground and a background and a defocus blur is serious.

### SUMMARY

The present disclosure provides user equipment and an image processing method and apparatus, which can improve accuracy in determining image depth information.

According to a first aspect, an embodiment of the present disclosure provides an image processing method, where the method includes:

obtaining an original image;

determining, according to the original image and at least two preset edge image blocks, a target blur value corresponding to a pixel in the original image, where each of the edge image blocks includes a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; and

determining a depth value corresponding to the pixel in the original image according to the target blur value corresponding to the pixel in the original image, where

the direction of the circular arc may be a clockwise direction of a tangent line through a midpoint of the circular arc, a counterclockwise direction of a tangent line through a midpoint of the circular arc, or a direction that points, from a midpoint of the circular arc, to a circle center corresponding to the circular arc.

With reference to the first aspect, in a first possible implementation manner of the first aspect,

the determining, according to the original image and at least two preset edge image blocks, a target blur value corresponding to a pixel in the original image includes:

establishing, according to the original image and the at least two edge image blocks, an energy function for blur values corresponding to pixels in the original image; and

determining, as the target blur value corresponding to the pixel in the original image, a blur value that is corresponding to a pixel in the original image and that minimizes a function value of the energy function.

In the first possible implementation manner of the first aspect, the energy function corresponding to the pixel in the original image is established according to the original image and the at least two edge image blocks, the target blur value corresponding to the pixel in the original image can be determined according to the energy function, and the depth value corresponding to the pixel in the original image can be determined according to the target blur value corresponding to the pixel in the original image. Therefore, there is no need to determine depth information of a pixel in an image according to a geometric relationship in the image or by assuming a defocus blur type of the image, thereby improving accuracy in determining image depth information.

With reference to the first possible implementation manner of the first aspect, in a second possible implementation manner of the first aspect,

the enemy function includes:

$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$

where

i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur degree value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, where when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

In the second possible implementation manner of the first aspect, the energy function is obtained according to the original image and the edge image blocks, the target blur value of the pixel in the original image is determined according to the energy function, and the depth value of the pixel in the original image can be determined according to the target blur value, thereby improving accuracy in determining depth information.

With reference to the second possible implementation manner of the first aspect, in a third possible implementation manner of the first aspect,

the determining, as the target blur value corresponding to the pixel in the original image, a blur value that is corresponding to a pixel in the original image and that minimizes a function value of the energy function includes:

decomposing the energy function to obtain a first subfunction and a second subfunction, where the first subfunction is:

$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$

and

the second subfunction is:

$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$

where

α and η are preset coefficients, tᵢ represents an intermediate blur value corresponding to the pixel i in the original image, and tⱼ represents an intermediate blur value corresponding to the pixel j in the original image; and

cyclically performing the following steps until a difference between t₁ and bᵢ meets a preset condition, and using bᵢ as a target blur value corresponding to the pixel i in the original image, where

the following steps include:

setting a value of t₁ to a fixed value and determining the blur value bᵢ that is corresponding to the pixel i in the original image and that minimizes a function value of the first subfunction; and

setting a value of bᵢ to a fixed value and determining the intermediate blur value tᵢ that is corresponding to the pixel i in the original image and that minimizes a function value of the second subfunction.

In the third possible implementation manner of the first aspect, the energy function is divided into the two subfunctions by introducing intermediate variables, and the target blur value of the pixel in the original image can be determined according to the two subfunctions. Therefore, complexity of determining the target blur value of the pixel in the original image can be reduced.

With reference to the third possible implementation manner of the first aspect, in a fourth possible implementation manner of the first aspect, the preset condition met by the difference between t₁ and bᵢ comprises: an absolute value of the difference between t₁ and bᵢ is less than or equal to a preset threshold.

With reference to the third possible implementation manner of the first aspect, in a fifth possible implementation manner of the first aspect,

before the step of decomposing the energy function into a first subfunction and a second subfunction, the method further includes:

obtaining an initial value corresponding to tᵢ.

With reference to any one of the first aspect, the first possible implementation manner of the first aspect, the second possible implementation manner of the first aspect, the third possible implementation manner of the first aspect, the fourth possible implementation manner of the first aspect, or the fifth possible implementation manner of the first aspect, in a sixth possible implementation manner of the first aspect,

after the step of determining a depth value corresponding to the pixel in the original image according to the target blur value corresponding to the pixel in the original image, the method further includes:

determining, according to the target blur value corresponding to the pixel in the original image and a depth order corresponding to the pixel in the original image, an energy function corresponding to depth values of pixels in the original image; and

determining, as a target depth value corresponding to the pixel in the original image, a depth value that is corresponding to a pixel in the original image and that minimizes a function value of the energy function corresponding to the depth values of the pixels in the original image.

In the sixth possible implementation manner of the first aspect, the depth value of the pixel in the original image can be corrected according to the depth order corresponding to the pixel in the original image and according to the depth value of the pixel in the original image to obtain the target depth value, so as to further improve accuracy in determining the depth value corresponding to the pixel in the original image.

With reference to the sixth possible implementation manner of the first aspect, in a seventh possible implementation manner of the first aspect,

the energy function corresponding to the depth values of the pixels in the original image is

$$arg {min}_{{S}_{i}} {\sum }_{i} {\vert {S}_{i} g sign ( {b}_{i} - {b}_{j} ) - sign ( {p}_{i} - {p}_{j} ) \vert}^{2} + β {\sum }_{\{ i , j \} ∈ N} T ( {S}_{i} \neq {S}_{j} ) ,$$

where

s represents a binary variable; sᵢ is used to represent whether the pixel i in the original image is a pixel at a long focal length or a pixel at a short focal length; sⱼ is used to represent whether the pixel j in the original image is a pixel at a long focal length or a pixel at a short focal length; T (g) represents an indicator function, where when sᵢ≠sⱼ, a returned result is 1, or otherwise, a returned result is 0; bᵢ represents a target blur value corresponding to the pixel i in the original image; bᵢ represents a target blur value corresponding to the pixel j in the original image; pᵢ represents a depth order value corresponding to the pixel i in the original image; p_{f} represents a depth order value corresponding to a pixel at a focal point in the original image; N represents a set of adjacent pixels in the original image; and sign (g) represents a sign function.

With reference to the seventh possible implementation manner of the first aspect, in an eighth possible implementation manner of the first aspect,

before the step of determining, according to the target blur value corresponding to the pixel in the original image and a depth order corresponding to the pixel in the original image, an energy function corresponding to depth values of pixels in the original image, the method further includes:

determining whether the pixel in the original image is a pixel at a long focal length or a pixel at a short focal length and a depth order value corresponding to the pixel in the original image.

According to a second aspect, an embodiment of the present disclosure provides an image processing apparatus, where the apparatus includes:

an obtaining unit, configured to obtain an original image;

a blur determining unit, configured to determine, according to the original image obtained by the obtaining unit and at least two preset edge image blocks, a target blur value corresponding to a pixel in the original image, where each of the edge image blocks includes a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; and

a depth determining unit, configured to determine a depth value corresponding to the pixel in the original image according to the target blur value that is corresponding to the pixel in the original image and that is determined by the blur determining unit.

With reference to the second aspect, in a first possible implementation manner of the second aspect,

the blur determining unit includes a modeling module and a solving module, where

the modeling module is configured to establish, according to the original image and the at least two edge image blocks, an energy function for blur values corresponding to pixels in the original image; and

the solving module is configured to determine, as the target blur value corresponding to the pixel in the original image, a blur value that is corresponding to a pixel in the original image and that minimizes a function value of the energy function.

With reference to the first possible implementation manner of the second aspect, in a second possible implementation manner of the second aspect,

the energy function includes:

$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$

where

i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, where when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

With reference to the second possible implementation manner of the second aspect, in a third possible implementation manner of the second aspect,

the blur determining unit further includes a decomposition module and a cycling module, where

the decomposition module is configured to decompose the energy function to obtain a first subfunction and a second subfunction, where the first subfunction is:

$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$

the second subfunction is:

$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$

where

α and η are preset coefficients, tᵢ represents an intermediate blur value corresponding to the pixel i in the original image, and tⱼ represents an intermediate blur value corresponding to the pixel j in the original image; and

the cycling module is configured to cyclically perform the following steps until a difference between tᵢ and bᵢ meets a preset condition, and use tᵢ or bᵢ as a target blur value corresponding to the pixel i in the original image, where

the following steps include:

the determining module is further configured to set a value of tᵢ to a fixed value and determine the blur value bᵢ that is corresponding to the pixel i in the original image and that minimizes a function value of the first subfunction; and

the determining module is further configured to set a value of bᵢ to a fixed value and determine the intermediate blur value tᵢ that is corresponding to the pixel i in the original image and that minimizes a function value of the second subfunction.

With reference to the third possible implementation manner of the second aspect, in a fourth possible implementation manner of the second aspect,

the preset condition met by the difference between tᵢ and bᵢ comprises: an absolute value of the difference between tᵢ and bᵢ is less than or equal to a preset threshold.

According to a third aspect, an embodiment of the present disclosure provides an image processing apparatus, including a memory and a processor, where

the memory is configured to store program code to be executed by the processor, and

the processor is configured to read the program code in the memory, to execute the method in the first aspect or any possible implementation manner of the first aspect.

According to a fourth aspect, a computer storage medium is provided, where the computer storage medium stores program code, and the program code is used to instruct to execute the method in the first aspect or any possible implementation manner of the first aspect.

According to the user equipment and the image processing method and apparatus that are provided in the present disclosure, an original image is first obtained; then a target blur value corresponding to a pixel in the original image is determined according to the original image and at least two preset edge image blocks, where each of the edge image blocks includes a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; finally, a depth value corresponding to the pixel in the original image is determined according to the target blur value corresponding to the pixel in the original image. Compared with the prior art, in the present disclosure, a blur value of a pixel in an original image is determined according to at least two preset edge image blocks, and a depth value corresponding to the pixel in the original image can be determined according to the blur value corresponding to the pixel in the original image. Therefore, to obtain depth for a multi-frame image, multi-frame input data is not required; to obtain depth for a single-frame image, there is no need to make an assumption about defocus blur graphics, thereby improving accuracy in determining image depth information.

### BRIEF DESCRIPTION OF DRAWINGS

To describe the technical solutions in the present disclosure or in the prior art more clearly, the following briefly describes the accompanying drawings required for describing the present disclosure or the prior art. Apparently, the accompanying drawings in the following description show merely some embodiments of the present disclosure, and a person of ordinary skill in the art may still derive other drawings from these accompanying drawings without creative efforts.

FIG. 1 is a flowchart of an image processing method according to an embodiment of the present disclosure;

FIG. 2 is a schematic diagram of a determined depth order of pixels in an image according to an embodiment of the present disclosure;

FIG. 3 is a flowchart of another image processing method according to an embodiment of the present disclosure;

FIG. 4 is a flowchart of still another image processing method according to an embodiment of the present disclosure;

FIG. 5 is a schematic diagram of an image processing apparatus according to an embodiment of the present disclosure;

FIG. 6 is a schematic diagram of another image processing apparatus according to an embodiment of the present disclosure; and

FIG. 7 is a schematic structural diagram of image processing apparatus according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

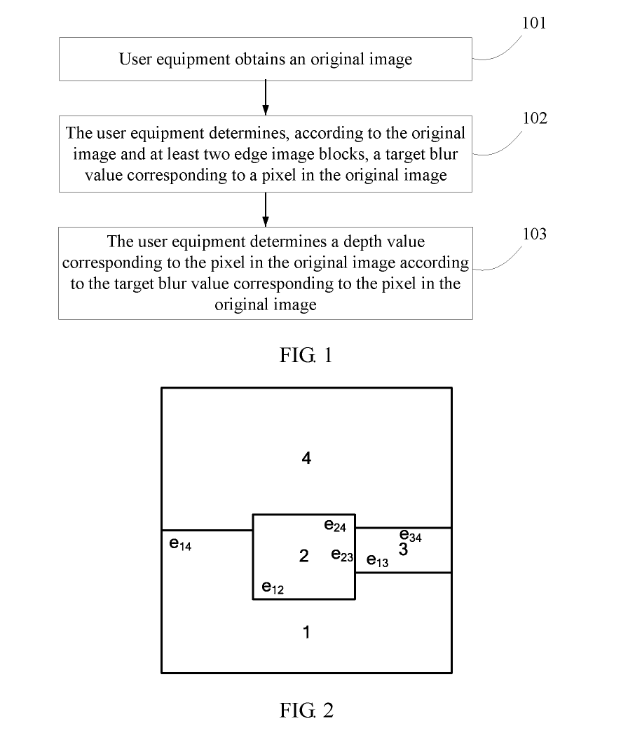

An embodiment of the present disclosure provides a method for determining image depth information, which can improve accuracy in determining image depth information. As shown in FIG. 1, the method includes:

101. User equipment obtains an original image.

102. The user equipment determines, according to the original image and at least two preset edge image blocks, a target blur value corresponding to a pixel in the original image.

Each of the edge image blocks includes a pixel used to describe a curve, and the curve is a circular arc or an elliptical arc. At least one pair of blur values, direction values, or curvature values of two edge image blocks in the at least two edge image blocks are different. A curvature of the edge image block is a curvature of a circular arc or an elliptical arc in the edge image block. A direction of the edge image block is a direction of the circular arc or the elliptical arc in the edge image block.

For example, a size of the edge image block may be 9×9, 10×10, or 11×11.

In this embodiment of the present disclosure, the user equipment may generate the foregoing at least two edge image blocks in advance and may locally store the at least two edge image blocks that are generated in advance.

103. The user equipment determines a depth value corresponding to the pixel in the original image according to the target blur value corresponding to the pixel in the original image.

In this embodiment of the present disclosure, the user equipment may determine the depth value corresponding to the pixel in the original image according to the target blur value corresponding to the pixel in the original image. In this embodiment of the present disclosure, after step 103, the method further includes: the user equipment first determines, according to the target blur value corresponding to the pixel in the original image and a depth order corresponding to the pixel in the original image, an energy function corresponding to depth values of pixels in the original image, and then determines, as a target depth value corresponding to the pixel in the original image, a depth value that is corresponding to a pixel in the original image and that minimizes a function value of the energy function corresponding to the depth values of the pixels in the original image.

The energy function corresponding to the depth values of the pixels in the original image is

$$arg {min}_{{S}_{i}} {\sum }_{i} {\vert {S}_{i} g sign ( {b}_{i} - {b}_{j} ) - sign ( {p}_{i} - {p}_{j} ) \vert}^{2} + β {\sum }_{\{ i , j \} ∈ N} T ( {S}_{i} \neq {S}_{j} ) ,$$

where

s represents a binary variable; sᵢ is used to represent whether a pixel i in the original image is a pixel at a long focal length or a pixel at a short focal length; sⱼ is used to represent whether a pixel j in the original image is a pixel at a long focal length or a pixel at a short focal length; T (g) represents an indicator function, where when sᵢ≠sⱼ, a returned result is 1, or otherwise, a returned result is 0; bᵢ represents a target blur value corresponding to the pixel i in the original image; bⱼ represents a target blur value corresponding to the pixel j in the original image; pᵢ represents a depth order value corresponding to the pixel i in the original image; p_{f} represents a depth order value corresponding to a pixel at a focal point in the original image; N represents a set of adjacent pixels in the original image; and sign (g) represents a sign function.

In this embodiment of the present disclosure, if bᵢ−bⱼ>0, sign(bᵢ−bⱼ)=1, or if bᵢ−bⱼ≦0, sign(bᵢ−bⱼ)=−1; if pᵢ−p_{f}>0, sign(pᵢ−p_{f})=1, or if pᵢ−p_{f}≦0, sign(pᵢ−p_{f})=−1.

In this embodiment of the present disclosure, a target blur value corresponding to a pixel in the original image and a depth value corresponding to the pixel in the original image are not in a simple correspondence. That is, target blur values corresponding to two pixels in the original image are the same, but depth values corresponding to the two pixels in the original image are not necessarily the same. Therefore, the user equipment needs to determine depth values corresponding to two pixels with a same blur value.

For this embodiment of the present disclosure, in the prior art, a person of skill in the art can determine, according to a geometric occlusion relationship in the original image, a depth order value corresponding to the pixel in the original image. In this embodiment of the present disclosure, the user equipment can correct, according to the depth order value corresponding to the pixel in the original image, the depth value that is corresponding to the pixel in the original image and that is determined according to the target blur value corresponding to the pixel in the original image, so as to obtain a more accurate depth value corresponding to the pixel in the original image.

For example, the user equipment determines a rough order value of depth information at each location in the original image according to a geometric occlusion relationship between sides of the original image. As shown in FIG. 2, at the bottom of a region 4, a T-shaped connection structure is formed by a region 1, a region 2, and the region 4. Therefore, the region 2 is above the region 1 and the region 4.

According to the image processing method provided in this embodiment of the present disclosure, an original image is first obtained; then a target blur value corresponding to a pixel in the original image is determined according to the original image and at least two preset edge image blocks, where each of the edge image blocks includes a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; finally, a depth value corresponding to the pixel in the original image is determined according to the target blur value corresponding to the pixel in the original image. Compared with the prior art, in this embodiment of the present disclosure, a blur value of a pixel in an original image is determined according to at least two preset edge image blocks, and a depth value corresponding to the pixel in the original image can be determined according to the blur value corresponding to the pixel in the original image. Therefore, to obtain depth for a multi-frame image, multi-frame input data is not required; to obtain depth for a single-frame image, there is no need to make an assumption about defocus blur graphics, thereby improving accuracy in determining image depth information.

In another possible implementation manner of this embodiment of the present disclosure, based on FIG. 1, step 102 of determining, by the user equipment, according to the original image and at least two preset edge image blocks, a target blur value corresponding to a pixel in the original image includes step 301 and step 302 shown in FIG. 3.

301. The user equipment establishes, according to the original image and the at least two edge image blocks, an energy function for blur values corresponding to pixels in the original image.

The enemy function includes

$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$

where

i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, where when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

For this embodiment of the present disclosure, ωᵢⱼ=exp (−|Iᵢ−Iⱼ|²/σₗ−|xᵢ−xⱼ|²/σₓ), where Iᵢ represents a color of the pixel i in the original image, Iⱼ represents a color of the pixel j in the original image, xᵢ represents coordinates of the pixel i in the original image, xⱼ represents coordinates of the pixel j in the original image, a value range of σₗ is (0, 1), and a value range of σₓ is (5, 10); ρ(∥f(Θ(∇Iᵢ))−T(θ,r,bᵢ)∥)=ln((l−e)exp(−|∥f(Θ(∇Iᵢ))−T(θ, r,bᵢ)∥|/σ)+e.

302. The user equipment determines, as the target blur value corresponding to the pixel in the original image, a blur value that is corresponding to a pixel in the original image and that minimizes a function value of the energy function.

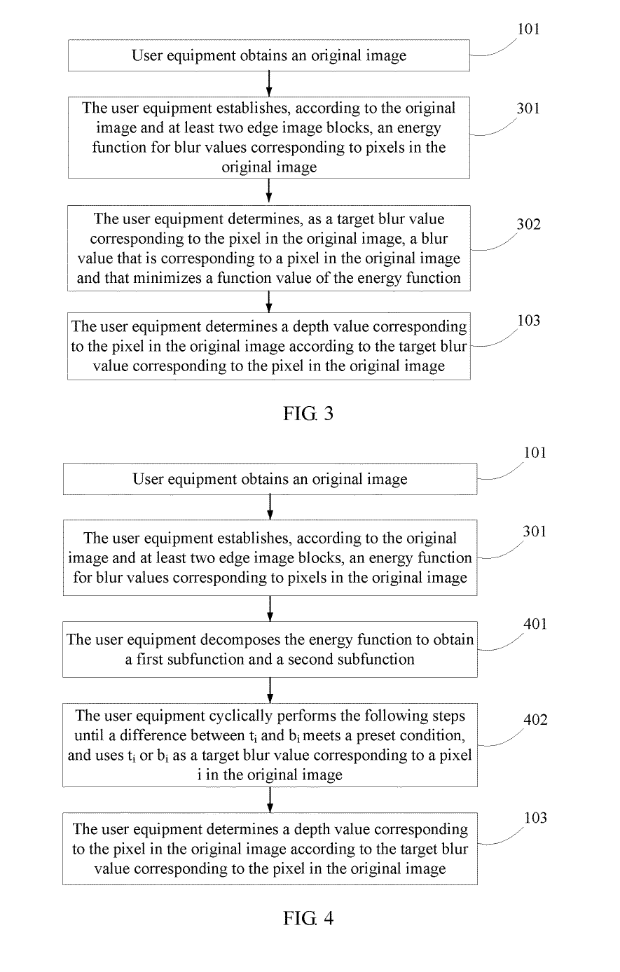

In another possible implementation manner of this embodiment of the present disclosure, based on FIG. 3, step 302 of determining, by the user equipment, a blur value corresponding to a pixel in the original image as the target blur value that is corresponding to a pixel in the original image and that minimizes a function value of the energy function, includes step 401 and step 402 shown in FIG. 4.

401. The user equipment decomposes the energy function to obtain a first subfunction and a second subfunction.

The first subfunction is

$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$

and the second subfunction is

$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$

where

α and η are preset coefficients, tᵢ represents an intermediate blur value corresponding to the pixel i in the original image, and tⱼ represents an intermediate blur value corresponding to the pixel j in the original image.

For this embodiment of the present disclosure, an initial value of tᵢ is generally 0.

402. The user equipment cyclically performs the following steps until a difference between tᵢ and bᵢ meets a preset condition, and uses tᵢ or bᵢ as a target blur value corresponding to a pixel i in the original image.

The following steps include step 302a and step 302b.

the preset condition met by the difference between t₁ and b₁ comprises: an absolute value of the difference between tᵢ and bᵢ is less than or equal to a preset threshold.

402a. The user equipment sets a value of tᵢ to a fixed value and determines the blur value bᵢ that is corresponding to the pixel i in the original image and that minimizes a function value of the first subfunction.

402b. The user equipment sets a value of bᵢ to a fixed value and determines the intermediate blur value tᵢ that is corresponding to the pixel i in the original image and that minimizes a function value of the second subfunction.

For this embodiment of the present disclosure, an energy function corresponding to a blur value of a pixel in an original image can be established according to the original image and at least two preset edge image blocks, a target blur value corresponding to the pixel in the original image can be determined according to the energy function, and a depth value corresponding to the pixel in the original image can be determined according to the target blur value corresponding to the pixel in the original image. Therefore, obtaining does not need to be performed according to defocus blur images in different regions to obtain a depth value of a pixel in an original image, thereby further improving accuracy in determining depth information.

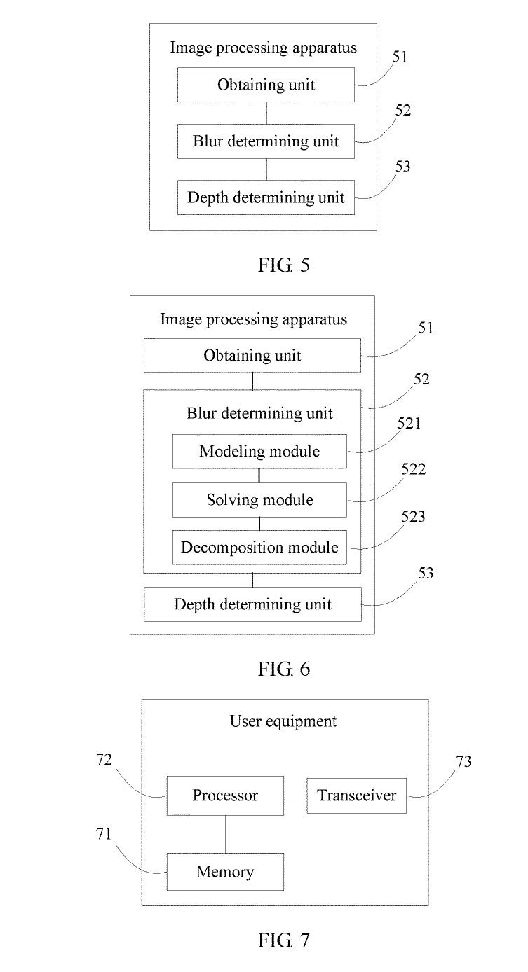

Further, as implementation of the method shown in FIG. 1, FIG. 3, and FIG. 4, an embodiment of the present disclosure further provides an image processing apparatus, which is configured to improve accuracy in determining depth information. As shown in FIG. 5, the apparatus includes an obtaining unit 51, a blur determining unit 52, and a depth determining unit 53.

The obtaining unit 51 is configured to obtain an original image.

The blur determining unit 52 is configured to determine, according to the original image obtained by the obtaining unit 51 and at least two edge image blocks, a target blur value corresponding to a pixel in the original image.

Each of the edge image blocks includes a pixel used to describe a curve, and the curve is a circular arc or an elliptical arc. At least one pair of blur values, direction values, or curvature values of two edge image blocks in the at least two edge image blocks are different. A curvature of the edge image block is a curvature of a circular arc or an elliptical arc in the edge image block. A direction of the edge image block is a direction of the circular arc or the elliptical arc in the edge image block.

The depth determining unit 53 is further configured to determine a depth value corresponding to the pixel in the original image according to the target blur value that is corresponding to the pixel in the original image and that is determined by the blur determining unit 52.

Further, as shown in FIG. 6, the blur determining unit 52 includes a modeling module 521 and a solving module 522.

The modeling module 521 is configured to establish, according to the original image and the at least two edge image blocks, an energy function for blur values corresponding to pixels in the original image.

The energy function includes

$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$

where

i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, where when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

The solving module 522 is configured to determine, as the target blur value corresponding to the pixel in the original image, a blur value that is corresponding to a pixel in the original image and that minimizes a function value of the energy function.

As shown in FIG. 6, the blur determining unit 52 further includes a decomposition module 523.

The decomposition module 523 is configured to: decompose the energy function to obtain a first subfunction and a second subfunction, where

the first subfunction is:

$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$

and

the second subfunction is:

$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$

where

α and η are preset coefficients, tᵢ represents an intermediate blur value corresponding to the pixel i in the original image, and tⱼ represents an intermediate blur value corresponding to the pixel j in the original image; and

cyclically perform the following steps until a difference between tᵢ and bᵢ meets a preset condition, and use tᵢ or bᵢ as a target blur value corresponding to the pixel i in the original image.

the preset condition met by the difference between tᵢ and bᵢ comprises: an absolute value of the difference between tᵢ and bᵢ is less than or equal to a preset threshold.

The following steps include:

setting a value of tᵢ to a fixed value and determining the blur value bᵢ that is corresponding to the pixel i in the original image and that minimizes a function value of the first subfunction; and

setting a value of bᵢ to a fixed value and determining the intermediate blur value tᵢ that is corresponding to the pixel i in the original image and that minimizes a function value of the second subfunction.

According to the image processing apparatus provided in this embodiment of the present disclosure, an original image is first obtained; then a target blur value corresponding to a pixel in the original image is determined according to the original image and at least two preset edge image blocks, where each of the edge image blocks includes a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; finally, a depth value corresponding to the pixel in the original image is determined according to the target blur value corresponding to the pixel in the original image. Compared with the prior art, in this embodiment of the present disclosure, a blur value of a pixel in an original image is determined according to at least two preset edge image blocks, and a depth value corresponding to the pixel in the original image can be determined according to the blur value corresponding to the pixel in the original image. Therefore, to obtain depth for a multi-frame image, multi-frame input data is not required; to obtain depth for a single-frame image, there is no need to make an assumption about defocus blur graphics, thereby improving accuracy in determining image depth information.

It should be noted that for other corresponding descriptions corresponding to devices involved in image processing and provided in this embodiment of the present disclosure, reference may be made to corresponding descriptions in any one of FIG. 1, FIG. 3, or FIG. 4, and details are not described herein again.

Still further, an embodiment of the present disclosure further provides user equipment. As shown in FIG. 7, the user equipment includes a memory 71, a processor 72, and a transceiver 73. Both the transceiver 73 and the memory 71 are connected to the processor 72. FIG. 7 describes a structure of the user equipment according to another embodiment of the present disclosure. The user equipment is configured to execute an authorized method implemented by the user equipment in the embodiment of FIG. 1, FIG. 3, and FIG. 4.

The memory 71 is configured to store program code to be executed by the processor.

The processor 72 obtains an original image; determines, according to the original image and at least two preset edge image blocks, a target blur value corresponding to a pixel in the original image; and determines a depth value corresponding to the pixel in the original image according to the target blur value corresponding to the pixel in the original image.

Each of the edge image blocks includes a pixel used to describe a curve, and the curve is a circular arc or an elliptical arc. At least one pair of blur values, direction values, or curvature values of two edge image blocks in the at least two edge image blocks are different. A curvature of the edge image block is a curvature of a circular arc or an elliptical arc in the edge image block. A direction of the edge image block is a direction of the circular arc or the elliptical arc in the edge image block.

The processor 72 is configured to establish, according to the original image and the at least two edge image blocks, an energy function for blur values corresponding to pixels in the original image; and determine, as the target blur value corresponding to the pixel in the original image, a blur value that is corresponding to a pixel in the original image and that minimizes a function value of the energy function.

The energy function includes

$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$

where

i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, where when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

The processor 72 is further configured to decompose the energy function to obtain a first subfunction and a second subfunction; and cyclically perform the following steps until a difference between tᵢ and bᵢ meets a preset condition, and use tᵢ or bᵢ as a target blur value corresponding to the pixel i in the original image. The following steps include: setting a value of tᵢ to a fixed value and determining the blur value bᵢ that is corresponding to the pixel i in the original image and that minimizes a function value of the first subfunction; and setting a value of bᵢ to a fixed value and determining the intermediate blur value tᵢ that is corresponding to the pixel i in the original image and that minimizes a function value of the second subfunction.

The first subfunction is

$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$

and the second subfunction is

$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$

where

α and η are preset coefficients, tᵢ represents an intermediate blur value corresponding to the pixel i in the original image, and tⱼ represents an intermediate blur value corresponding to the pixel j in the original image.

the preset condition met by the difference between tᵢ and bᵢ comprises: an absolute value of the difference between tᵢ and bᵢ is less than or equal to a preset threshold.

The transceiver 73 is configured to receive the original image or send the depth value corresponding to the pixel in the original image.

According to the user equipment provided in this embodiment of the present disclosure, an original image is first obtained; then a target blur value corresponding to a pixel in the original image is determined according to the original image and at least two preset edge image blocks, where each of the edge image blocks includes a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; finally, a depth value corresponding to the pixel in the original image is determined according to the target blur value corresponding to the pixel in the original image. Compared with the prior art, in this embodiment of the present disclosure, a blur value of a pixel in an original image is determined according to at least two preset edge image blocks, and a depth value corresponding to the pixel in the original image can be determined according to the blur value corresponding to the pixel in the original image. Therefore, to obtain depth for a multi-frame image, multi-frame input data is not required; to obtain depth for a single-frame image, there is no need to make an assumption about defocus blur graphics, thereby improving accuracy in determining image depth information.

It should be noted that for other corresponding descriptions corresponding to devices involved in image processing and provided in this embodiment of the present disclosure, reference may be made to corresponding descriptions in any one of FIG. 1, FIG. 3, or FIG. 4, and details are not described herein again.

The image processing apparatus according to the embodiments of the present disclosure can implement the method embodiment provided above, and for specific function implementation, reference may be made to descriptions in the method embodiment and details are not described herein again. The user equipment and the image processing method and apparatus that are provided in the embodiments of the present disclosure may be applicable to determining of a blur value corresponding to a pixel in an image and determining of a depth value corresponding to the pixel in the image according to the blur value corresponding to the pixel in the image. However, the present disclosure is not limited thereto.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (ROM), or a random access memory (RAM).

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An image processing method, comprising:
obtaining an original image;
determining, according to the original image and at least two preset edge image blocks, a target blur value corresponding to a pixel in the original image, wherein each of the edge image blocks comprises a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; and
determining a depth value corresponding to the pixel in the original image according to the target blur value corresponding to the pixel in the original image.

2. The method according to claim 1, wherein the determining, according to the original image and at least two preset edge image blocks, a target blur value corresponding to a pixel in the original image comprises:
establishing, according to the original image and the at least two edge image blocks, an energy function for blur values corresponding to pixels in the original image; and
determining, as the target blur value corresponding to the pixel in the original image, a blur value that is corresponding to a pixel in the original image and that minimizes a function value of the energy function.

3. The method according to claim 2, wherein the energy function comprises:
$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$
wherein
i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, wherein when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

4. The method according to claim 3, wherein the determining, as the target blur value corresponding to the pixel in the original image, a blur value that is corresponding to a pixel in the original image and that minimizes a function value of the energy function comprises:
decomposing the energy function to obtain a first subfunction and a second subfunction, wherein the first subfunction is:
$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$
and
the second subfunction is:
$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$
wherein
α and η are preset coefficients, tᵢ represents an intermediate blur value corresponding to the pixel i in the original image, and tⱼ represents an intermediate blur value corresponding to the pixel j in the original image; and
cyclically performing the following steps until a difference between tᵢ and bᵢ meets a preset condition, and using bᵢ as a target blur value corresponding to the pixel i in the original image, wherein
the following steps comprise:
setting a value of tᵢ to a fixed value and determining the blur value bᵢ that is corresponding to the pixel i in the original image and that minimizes a function value of the first subfunction; and
setting a value of bᵢ to a fixed value and determining the intermediate blur value tᵢ that is corresponding to the pixel i in the original image and that minimizes a function value of the second subfunction.

5. The method according to claim 4, wherein the preset condition met by the difference between tᵢ and bᵢ comprises: an absolute value of the difference between tᵢ and bᵢ is less than or equal to a preset threshold.

6. An image processing apparatus, comprising:
an obtaining unit, configured to obtain an original image;
a blur determining unit, configured to determine, according to the original image obtained by the obtaining unit and at least two preset edge image blocks, a target blur value corresponding to a pixel in the original image, wherein each of the edge image blocks comprises a pixel used to describe a curve, the curve is a circular arc or an elliptical arc, at least one pair of blur values, direction values, or curvature values of two edge image blocks in the at least two edge image blocks are different, a curvature of the edge image block is a curvature of a circular arc or an elliptical arc in the edge image block, and a direction of the edge image block is a direction of the circular arc or the elliptical arc in the edge image block; and
a depth determining unit, configured to determine a depth value corresponding to the pixel in the original image according to the target blur value that is corresponding to the pixel in the original image and that is determined by the blur determining unit.

7. The apparatus according to claim 6, wherein the blur determining unit comprises a modeling module and a solving module, wherein
the modeling module is configured to establish, according to the original image and the at least two edge image blocks, an energy function for blur values corresponding to pixels in the original image; and
the solving module is configured to determine, as the target blur value corresponding to the pixel in the original image, a blur value that is corresponding to a pixel in the original image and that minimizes a function value of the energy function.

8. The apparatus according to claim 7, wherein the energy function comprises:
$${\sum }_{i} {min}_{θ , r} {m}_{i} ρ ( ‖ f ( Θ ( ∇ {I}_{i} ) ) - T ( θ , r , {b}_{i} ) ‖ ) + {\sum }_{\{ i , j \} ∈ W} {ω}_{ij} {\vert {b}_{i} - {b}_{j} \vert}^{2} ,$$
wherein
i represents a pixel in the original image; Iᵢ represents the original image; ∇Iᵢ represents a gradient image of Iᵢ; Θ(∇Iᵢ) represents an image block that is in ∇Iᵢ and to which the pixel i in the original image belongs; f(•) represents a normalizing function; T(θ, r, bᵢ) represents an edge image block, whose direction value is θ, curvature value is r, and blur value is bᵢ, in the at least two edge image blocks; ωᵢⱼ represents a smoothed weight corresponding to i and j; bᵢ represents a blur value corresponding to the pixel i in the original image; bⱼ represents a blur value corresponding to a pixel j in the original image; mᵢ is used to represent whether the pixel i in the original image is an edge pixel of the original image, wherein when mᵢ=1, it represents that the pixel i in the original image is an edge pixel of the original image, and when mᵢ=0, it represents that the pixel i in the original image is not an edge pixel of the original image; ρ(•) represents a robust function; and W represents a set of adjacent pixels.

9. The apparatus according to claim 8, wherein
the decomposition module is configured to: decompose the energy function to obtain a first subfunction and a second subfunction, wherein the first subfunction is:
$${\sum }_{i} {min}_{θ , r} {m}_{i} ρ ( ‖ f ( Θ ( ∇ {I}_{i} ) ) - T ( θ , r , {b}_{i} ) ‖ ) + η {\vert {b}_{i} - {t}_{i} \vert}^{2} ,$$
and
the second subfunction is:
$${\sum }_{i} {m}_{i} {\vert {t}_{i} - {b}_{i} \vert}^{2} + \frac{α}{η} {\sum }_{\{ i , j \} ∈ W} {ω}_{ij} {\vert {t}_{i} - {t}_{j} \vert}^{2} ,$$
wherein
α and η are preset coefficients, tᵢ represents an intermediate blur value corresponding to the pixel i in the original image, and tⱼ represents an intermediate blur value corresponding to the pixel j in the original image; and
cyclically perform the following steps until a difference between tᵢ and bᵢ meets a preset condition, and use tᵢ or bᵢ as a target blur value corresponding to the pixel i in the original image, wherein
the following steps comprise:
setting a value of tᵢ to a fixed value and determining the blur value bᵢ that is corresponding to the pixel i in the original image and that minimizes a function value of the first subfunction; and
setting a value of bᵢ to a fixed value and determining the intermediate blur value tᵢ that is corresponding to the pixel i in the original image and that minimizes a function value of the second subfunction.
